(19) United States
(12) Patent Application Publication
(10) Pub. No.: US 2024/0239018 A1
(43) Pub. Date: Jul. 18, 2024

(54) KNEADING STATE DETECTION DEVICE AND KNEADING STATE DETECTION METHOD FOR EXTRUSION MOLDING MACHINE

(71) Applicants: Shibaura Machine Co., Ltd., Chiyoda-ku (JP); NATIONAL UNIVERSITY CORPORATION KANAZAWA UNIVERSITY, Kanazawa-shi (JP)

(72) Inventors: Masatoshi OHARA, Numazu-shi (JP); Kentaro TAKI, Kanazawa-shi (JP)

(73) Assignees: Shibaura Machine Co., Ltd., Chiyoda-ku (JP); NATIONAL UNIVERSITY CORPORATION KANAZAWA UNIVERSITY, Kanazawa-shi (JP)

(21) Appl. No.: 18/557,093

(22) PCT Filed: Apr. 25, 2022
(86) PCT No.: PCT/JP2022/018717

§ 371 Date: Oct. 25, 2023

(30) Foreign Application Priority Data
May 17, 2021 (JP) 2021-082978

(51) Int. Cl. B29B 7/72; B29B 7/48; G01N 29/14; G01N 29/44; G01N 29/46

(52) U.S. Cl. CPC B29B 7/72; B29B 7/48; G01N 29/14; G01N 29/4427; G01N 29/4472; G01N 29/46; G01N 2291/0231

(57) ABSTRACT

A kneading state detection device includes an acquisition unit that, when an extrusion molding machine that kneads a raw material or kneads a raw material and an additive is in operation, acquires an output of an AE sensor installed on a housing of the extrusion molding machine, and a determination unit that determines a kneading state of the raw material, based on a comparison between a change in intensity of the output of the AE sensor acquired by the acquisition unit and a threshold.

### TECHNICAL FIELD

The present invention relates to a kneading state detection device and a kneading state detection method for an extrusion molding machine.

### BACKGROUND ART

Conventionally, the kneading state of raw materials by an extrusion molding machine has been determined on the basis of, for example, an elapsed time from the start of kneading, a measurement value of a pressure sensor that measures the internal pressure of the extrusion molding machine, a measurement value of a temperature sensor that measures the internal temperature of the extrusion molding machine, a torque variation value of a motor that drives the extrusion molding machine, a current value flowing through the motor, and the like (see Patent Literatures 1, 2, and 3).

### CITATION LIST

### Patent Literature

Patent Literature 1: JP 2019-513177 A
Patent Literature 2: JP H08-258114 A
Patent Literature 3: JP H10-100235 A

### SUMMARY OF INVENTION

### Problem to be Solved by the Invention

In any of such conventional determination methods, the kneading state of raw materials is indirectly monitored, and thus the kneading state is not directly monitored. In addition, depending on the raw materials to be kneaded, the variation amount of a physical quantity to be measured is very small, and thus it is necessary to rely on experience and intuition to determine the kneading state.

The present invention has been made in view of the above, and an object thereof is to provide a kneading state detection device and a kneading state detection method for an extrusion molding machine capable of reliably detecting the kneading state of raw materials in real time.

### Means for Solving Problem

In order to solve the above problem and achieve the object, a kneading state detection device for an extrusion molding machine according to the present invention, includes: an acquisition unit that, when an extrusion molding machine that kneads a raw material or kneads a raw material and an additive is in operation, acquires an output of an AE sensor installed on a housing of the extrusion molding machine; and a determination unit that determines a kneading state of the raw material or the raw material and the additive, based on a comparison between a change in intensity of the output of the AE sensor acquired by the acquisition unit over a predetermined time and a threshold

### Effect of the Invention

The kneading state detection device and the kneading state detection method for an extrusion molding machine according to the present invention can reliably detecting the kneading state of the raw material in real time.

### BRIEF DESCRIPTION OF DRAWINGS

FIG. 1 is an explanatory diagram of acoustic emission;

FIG. 2 is a schematic structural diagram of an AE sensor;

FIG. 3 is a schematic structural view illustrating an example of a kneading state detection device for a twin-screw extrusion molding machine;

FIG. 4 is a cross-sectional view of an output shaft of the twin-screw extrusion molding machine;

FIG. 5 is a hardware block diagram illustrating an example of a hardware configuration of the kneading state detection device for the twin-screw extrusion molding machine according to an embodiment;

FIG. 6 is a diagram illustrating an example of a result of frequency analysis of AE waves acquired by an AE wave analysis device;

FIG. 7 is a diagram illustrating an example of a temporal change in an integrated value of a power spectrum of AE waves acquired by the AE wave analysis device in a range of 60 KHz to 80 KHz;

FIG. 8 is a diagram for explaining a method of determining whether the broken state of glass fiber is stabilized on the basis of the waveform of the AE wave acquired by the AE wave analysis device;

FIG. 9 is a functional block diagram illustrating an example of a functional configuration of the kneading state detection device for the twin-screw extrusion molding machine according to the embodiment;

FIG. 10 is a flowchart illustrating an example of a flow of a process performed by the kneading state detection device;

FIG. 11 is a diagram illustrating an example of the temporal change in the integrated value of the power spectrum when the rotation speed of a screw is changed in a state where the resin raw material and the glass fiber are sufficiently kneaded by continuously operating the twin-screw extrusion molding machine;

FIG. 12 is a diagram illustrating an example of the temporal change in the integrated value of the power spectrum when the feeding flow rate of the resin raw material is changed in a state where the resin raw material and the glass fiber are sufficiently kneaded by continuously operating the twin-screw extrusion molding machine; and

FIG. 13 is a diagram illustrating an example of the temporal change in the integrated value of the power spectrum when the feeding flow rate of the glass fiber is changed in a state where the resin raw material and the glass fiber are sufficiently kneaded by continuously operating the twin-screw extrusion molding machine.

### DESCRIPTION OF EMBODIMENTS

### [Description of Acoustic Emission (AE)]

Before the description of embodiments, acoustic emission (hereinafter, referred to as “AE”) used for detecting a kneading state in an extrusion molding machine in operation will be described. The AE is, for example, a phenomenon in which at the time of kneading a resin raw material (pellets) by the extrusion molding machine, when resin pellets as a solid material are crushed or when a reinforcing material such as glass fiber, carbon fiber, or cellulose fiber mixed to reinforce the resin raw material is broken, strain energy accumulated so far is emitted as a sound wave (an elastic wave, an AE wave). By detecting and analyzing the AE wave generated due to the crushing of the resin pellets or the breakage of the reinforcing material, the kneading state of the resin material fed into the extrusion molding machine and the kneading state of the reinforcing material can be predicted. The frequency band of the AE wave is said to be about several tens kHz to several MHz, and has a frequency band that cannot be detected by a general vibration sensor or acceleration sensor. Consequently, a dedicated AE sensor is used to detect the AE wave. The AE sensor will be described later in detail. Note that, in the present embodiment, it is assumed that the reinforcing material is mixed in the resin raw material, but the material to be mixed is not limited to the reinforcing material. For example, even in a case where an additive such as talc, calcium carbonate, or magnesium carbonate is mixed, the following description is similarly applied.

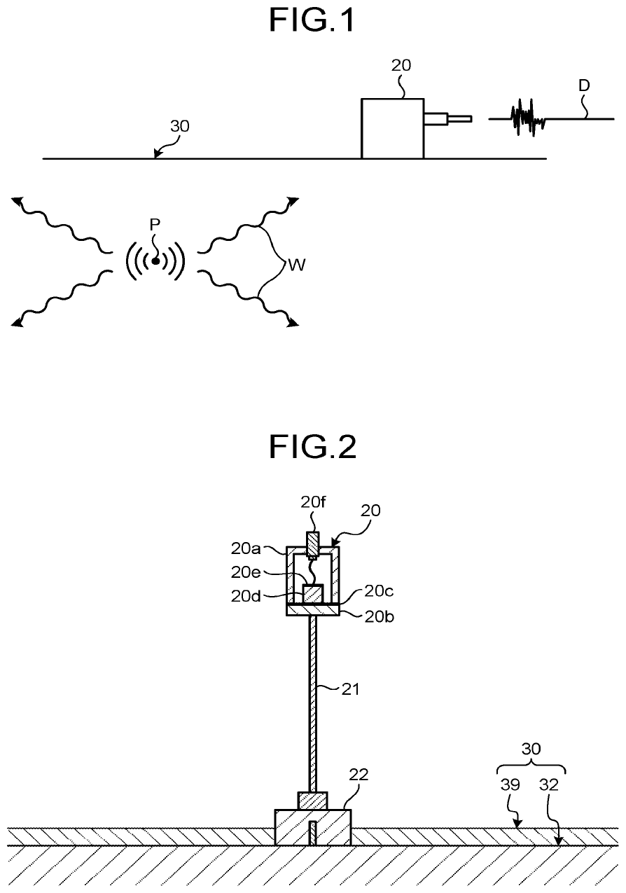

FIG. 1 is an explanatory diagram of acoustic emission and an AE sensor. As illustrated in FIG. 1, for example, when the resin pellets are crushed or the reinforcing material is broken at a point P inside a twin-screw extrusion molding machine 30, AE waves W are generated. The AE wave W spreads radially from the point P and enters the inside of a housing of the twin-screw extrusion molding machine 30. The AE wave W having entered inside of the housing propagates inside the housing of the twin-screw extrusion molding machine 30.

The AE wave W propagating inside the housing of the twin-screw extrusion molding machine 30 is detected by an AE sensor 20 installed on the surface of the housing of the twin-screw extrusion molding machine 30. The AE sensor 20 then outputs a detection signal D. Since the detection signal D is a signal representing vibration, the detection signal D is an AC signal with positive and negative values as illustrated in FIG. 1. However, in this state, it is difficult to use the detection signal D (the AE wave W) when performing various calculations, and thus, it is common to use a rectified waveform obtained by performing half-wave rectification on the negative portion of the detection signal D. Furthermore, when the AE wave W is analyzed, in general, a value obtained by averaging the square value of the rectified waveform over a predetermined time and taking its square root, that is, an effective value (a root mean square (RMS) value) is used.

The propagation speed of the AE wave W is different between a longitudinal wave and a lateral wave (the longitudinal wave is faster than the lateral wave). However, in consideration of the size (the propagation distance) of the solid material Q, the difference can be ignored. Consequently, in the present embodiment, the AE wave W detected within a predetermined time is analyzed as a measurement signal without any distinction between the longitudinal wave and the lateral wave.

FIG. 2 is a schematic structural diagram of an AE sensor. As illustrated in FIG. 2, the AE sensor 20 is installed at the distal end of a waveguide rod 21 (a waveguide) installed in contact with the surface of a housing (barrel) 32 of a twin-screw extrusion molding machine 30 to be detected in a state of being enclosed in a shield case 20a. The waveguide rod 21 is made of ceramic or stainless steel, and transmits the AE wave W transmitted inside the housing 32 to the AE sensor 20.

A heater 39 for melting resin pellets is mounted on the surface of the housing 32 of the twin-screw extrusion molding machine 30 and a high temperature of about 200° C. is obtained, and thus the AE sensor 20 cannot be directly installed on the housing 32. For this reason, the AE sensor 20 is installed via the waveguide rod 21. A magnet 22 is installed at the distal end of the waveguide rod 21 closer to the twin-screw extrusion molding machine 30, and the waveguide rod 21 is fixed on the surface of the housing 32 of the twin-screw extrusion molding machine 30 by the magnet 22 so as to avoid the position of the heater 39. Alternatively, the distal end of the waveguide rod 21 closer to the twin-screw extrusion molding machine 30 may be fixed on the surface of the housing 32 by screwing.

The other end of the waveguide rod 21 is connected to a wave receiving surface 20b of the AE sensor 20. Note that in order to improve the adhesion between the AE sensor 20 and the waveguide rod 21, grease may be applied on the wave receiving surface 20b of the AE sensor 20. A vapor deposited film 20c made of copper or the like is formed on the wave receiving surface 20b. A piezoelectric element 20d made of lead zirconate titanate (PZT) or the like is disposed on the vapor deposited film 20c. The piezoelectric element 20d receives the AE wave W transmitted inside the waveguide rod 21 via the wave receiving surface 20b, and outputs an electric signal corresponding to the AE wave W. The electrical signal output from the piezoelectric element 20d is output as the detection signal D via a vapor deposited film 20e and a connector 20f. Note that since the detection signal D is weak, in order to suppress the influence of noise mixture, a preamplifier (not illustrated in FIG. 2) may be installed inside the AE sensor 20, and the detection signal D may be amplified in advance and then output.

Hereinafter, embodiments of a kneading state detection device for an extrusion molding machine according to the present disclosure will be described in detail with reference to the drawings. Note that the present invention is not limited by these embodiments. In addition, constituent elements in the following embodiments include those that can be replaced by those skilled in the art and can be easily conceived, or those that are substantially the same.

### First Embodiment

A first embodiment of the present disclosure is an example of a kneading state detection device for a twin-screw extrusion molding machine that determines the kneading state of glass fiber mixed into a resin raw material. Note that the twin-screw extrusion molding machine is an example, and the present embodiment is applicable to all extrusion molding machines such as a single-screw extrusion molding machine and a multi-screw extrusion molding machine.

### [Schematic Structure of Twin-Screw Extrusion Molding Machine]

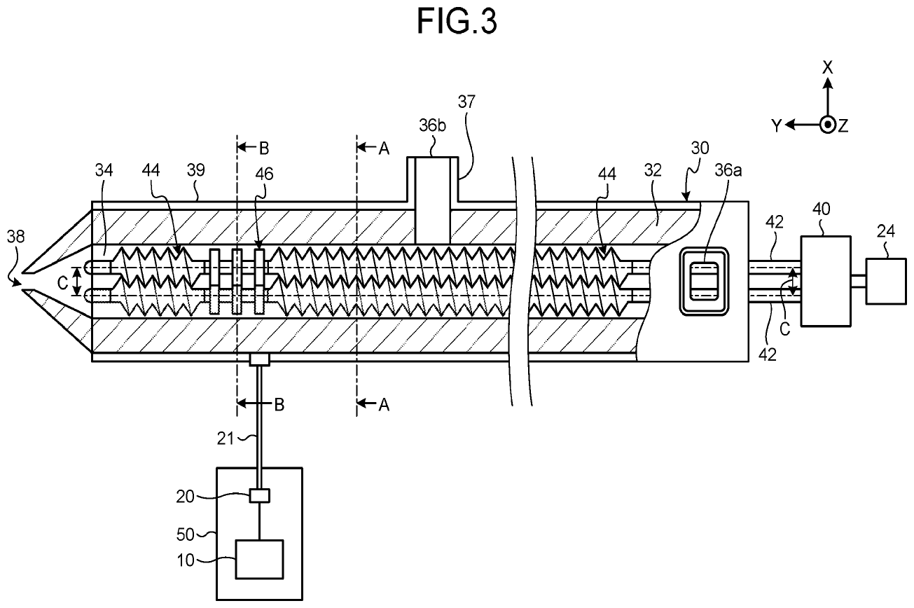

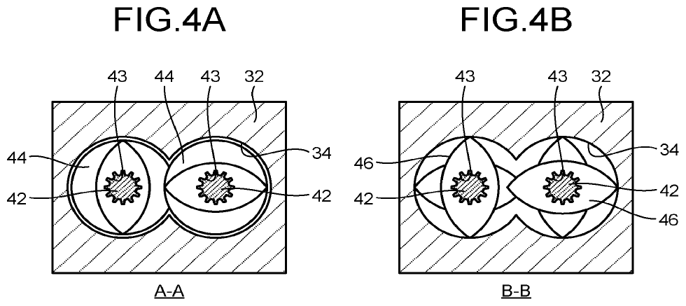

First, a schematic structure of a kneading state detection device 50 for the twin-screw extrusion molding machine 30 according to the present embodiment will be described with reference to FIGS. 3 and 4. FIG. 3 is a schematic structural view illustrating an example of the kneading state detection device for the twin-screw extrusion molding machine. FIG. 4 is a cross-sectional view of an output shaft of the twin-screw extrusion molding machine.

The twin-screw extrusion molding machine 30 is driven according to the output of a gear box 40. That is, the gear box 40 decelerates the rotational driving force of a motor 24 to rotationally drive two output shafts 42 included in the twin-screw extrusion molding machine 30 in the same direction. A screw 44 and a kneading disk 46, which will be described later, are installed on the outer periphery of the output shaft 42, and with the rotation of the output shaft 42, a resin raw material (resin pellets) fed into the twin-screw extrusion molding machine 30 is plasticized and melted for kneading and molding, and a reinforcing material such as glass fiber is mixed and kneaded in the resin raw material to improve the strength of the resin raw material. Note that the twin-screw extrusion molding machine 30 is an example of an extrusion molding machine in the present disclosure.

Note that the two output shafts 42 are arranged in parallel with each other along a Y axis with a certain inter-shaft distance C along an X axis in the cylindrical housing (barrel) 32 of the twin-screw extrusion molding machine 30.

FIG. 4 (a) is a cross-sectional view of the twin-screw extrusion molding machine 30 taken along a line A-A. As illustrated in FIG. 4 (a), the output shaft 42 is inserted into a spline hole 43 formed in the screw 44. The output shaft 42 meshes with the spline hole 43 to rotate the screw 44 inside an insertion hole 34.

FIG. 4 (b) is a cross-sectional view of the twin-screw extrusion molding machine 30 taken along a line B-B. As illustrated in FIG. 4 (a), the output shaft 42 is inserted into the spline hole 43 formed in the kneading disk 46. The output shaft 42 meshes with the spline hole 43 to rotate the kneading disk 46 inside the insertion hole 34.

The screw 44 rotates, for example, at a speed of 300 revolutions per minute or the like to convey the molten resin raw material fed into the twin-screw extrusion molding machine 30 and the glass fiber mixed in the resin raw material, downstream in the twin-screw extrusion molding machine 30. The screws 44 of the output shafts 42 mesh with each other to convey the molten resin raw material downstream. In addition, the glass fiber mixed in the resin raw material is broken by receiving a large shearing force when passing through the meshing portion of the screw 44 provided in each output shaft 42.

The kneading disk 46 has a structure in which a plurality of elliptical disks is arranged in a direction orthogonal to the output shaft 42 and the directions of disks adjacent to each other along the output shaft 42 are shifted. Adjacent disks are arranged in a shifted manner to divide the flow of the resin raw material between the disks, thereby promoting kneading of the conveyed resin raw material and the glass fiber mixed in the resin raw material. That is, the kneading disk 46 applies shear energy to the resin raw material that is heated by the heater 39 and conveyed by the screw 44 to completely melt the resin raw material.

The insertion hole 34 into which each output shaft 42 is inserted is formed inside the housing 32. The insertion hole 34 is a hole formed along the longitudinal direction of the housing 32, and has a shape in which cylinders overlap partially. As a result, the screw 44 and the kneading disk 46 can be inserted into the insertion hole 34 in a state of being meshed with each other.

Returning to FIG. 3 again, at one end of the housing 32 in the longitudinal direction, a supply port 36a for feeding the pellet-like resin raw material and the material of a powdery filler, which are to be kneaded, into the insertion hole 34 is provided. A reinforcing material such as glass fiber is fed from a supply port 36b provided in a side feeder 37 downstream of the supply port 36a. Note that the supply direction of the raw material through the supply ports 36a and 36b is not limited to the example illustrated in FIG. 3.

A discharge port 38 that discharges the material kneaded while passing through the insertion hole 34 is provided at the other end of the housing 32 in the longitudinal direction. In addition, the heater 39 that heats the housing 32 to heat the resin raw material fed into the insertion hole 34 is provided on the outer periphery of the housing 32.

Note that in the example of FIG. 3, the output shaft 42 of the twin-screw extrusion molding machine 30 includes the screw 44 at two parts and the kneading disk 46 at one part, but the numbers of the screws 44 and the kneading disks 46 are not limited to the example illustrated in FIG. 3. For example, the kneading disk 46 may be installed at a plurality of parts to knead the resin raw material and the glass fiber.

The AE sensor 20 is installed on the surface of the housing 32 of the twin-screw extrusion molding machine 30 downstream of the supply port 36b via the waveguide rod 21. The output of the AE sensor 20 is then input to an AE wave analysis device 10. The AE sensor 20 and the AE wave analysis device 10 constitute the kneading state detection device 50. In order to detect the AE wave W with higher sensitivity, as illustrated in FIG. 3, the AE sensor 20 is desirably installed in the vicinity of the kneading disk 46 that is a main source of generation of the AE wave W at the time of kneading raw materials.

The configuration and function of the AE sensor 20 are as described above.

The AE wave analysis device 10 analyzes the frequency component of the AE wave W output from the AE sensor 20 to determine whether the broken state of the glass fiber fed into the twin-screw extrusion molding machine 30 is stabilized. Stabilizing the broken state of the glass fiber means that the resin raw material and the glass fiber are sufficiently kneaded, and a molded article in a state where the quality can be ensured is discharged from the discharge port 38. In other words, it is a state where there is no temporal change in the breaking amount of the glass fiber or the kneading condition of the resin raw material and the glass fiber at each element point inside the twin-screw extrusion molding machine 30. This state is also referred to as “steady state”. Hereinafter, the stable kneading state of raw materials is also referred to as “steady state”. Note that the method related to the frequency component of the AE wave W will be described later.

### [Hardware Configuration of Kneading State Detection Device]

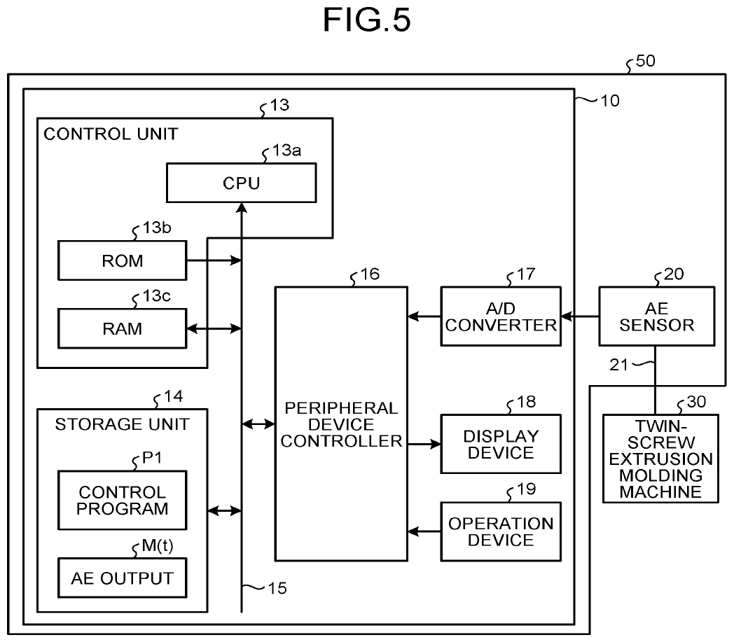

Next, a hardware configuration of the kneading state detection device 50 for the twin-screw extrusion molding machine 30 will be described with reference to FIG. 5. FIG. 5 is a hardware block diagram illustrating an example of a hardware configuration of the kneading state detection device for the twin-screw extrusion molding machine according to the embodiment.

The kneading state detection device 50 is used in connection with the twin-screw extrusion molding machine 30, and includes the AE wave analysis device 10 and the AE sensor 20. The AE wave analysis device 10 includes a control unit 13, a storage unit 14, and a peripheral device controller 16.

The control unit 13 includes a central processing unit (CPU) 13a, a read only memory (ROM) 13b, and a random access memory (RAM) 13c. The CPU 13a is connected to the ROM 13b and the RAM 13c via a bus line 15. The CPU 13a reads a control program P1 stored in the storage unit 14 and develops the control program P1 in the RAM 13c. The CPU 13a operates in accordance with the control program P1 developed in the RAM 13c to control the operation of the control unit 13. That is, the control unit 13 has a configuration of a general computer that operates on the basis of the control program P1.

The control unit 13 is further connected to the storage unit 14 and the peripheral device controller 16 via the bus line 15.

The storage unit 14 is a non-volatile memory such as a flash memory, a hard disk drive (HDD), or the like that retains stored information even when the power is turned off. The storage unit 14 stores a program including the control program P1 and an AE output M(t) output from the AE sensor 20 at the time t. The control program P1 is a program for implementing the function of the control unit 13. The AE output M(t) is a signal obtained by converting the effective value of the detection signal D output from the AE sensor 20 into a digital signal by an A/D converter 17.

Note that the control program P1 may be provided by being incorporated in the ROM 13b in advance. Alternatively, it may be configured that the control program P1 is provided by being recorded in a computer-readable recording medium such as a CD-ROM, a flexible disk (FD), a CD-R, or a digital versatile disc (DVD) as a file in a format that can be installed or executed in the control unit 13. Furthermore, it may be configured that the control program P1 is stored on a computer connected to a network such as the Internet and provided by being downloaded via the network. Further, it may be configured that the control program P1 is provided or distributed via a network such as the Internet.

The peripheral device controller 16 is connected to the A/D converter 17, a display device 18, and an operation device 19. The peripheral device controller 16 controls the operation of various connected hardware on the basis of a command from the control unit 13.

The A/D converter 17 converts the detection signal D output from the AE sensor 20 into a digital signal and outputs the AE output M(t). Note that the AE sensor 20 detects the AE wave W transmitted through the housing 32 of the twin-screw extrusion molding machine 30 via the waveguide rod 21 as described earlier. Note that, although not illustrated in FIG. 5, the AE wave W output from the AE sensor 20 is amplified by an amplifier and then input to the A/D converter 17.

The display device 18 is, for example, a liquid crystal display. The display device 18 displays various types of information related to the operation state of the kneading state detection device 50. In addition, the display device 18 makes notification that the resin raw material and the glass fiber fed into the twin-screw extrusion molding machine 30 are kneaded so that the kneading state detection device 50 reaches the steady state.

The operation device 19 is, for example, a touch panel superimposed on the display device 18. The operation device 19 acquires operation information related to various operations performed by an operator on the kneading state detection device 50 for the twin-screw extrusion molding machine 30.

Note that the AE sensor 20 is installed on the surface of the housing 32 of the twin-screw extrusion molding machine 30 in the configuration described in FIGS. 2 and 3. In addition, the frequency band of a signal that can be detected by the AE sensor 20 varies depending on the type of the AE sensor. Therefore, when the AE sensor 20 to be used is selected, it is desirable to select the AE sensor 20 that has high sensitivity with respect to the frequency band of the AE wave W expected to be generated by kneading, in consideration of the raw material to be measured, the operating conditions of the twin-screw extrusion molding machine 30, and the like.

### [Analysis of AE Wave Generated by Breakage of Glass Fiber]

The inventors temporarily supplied a certain amount of glass fiber for increasing the strength of the resin raw material from the supply port 36b to the molten resin pellets conveyed inside the twin-screw extrusion molding machine 30 illustrated in FIG. 3, and observed the AE waves W output when the glass fiber was broken by the AE sensor 20.

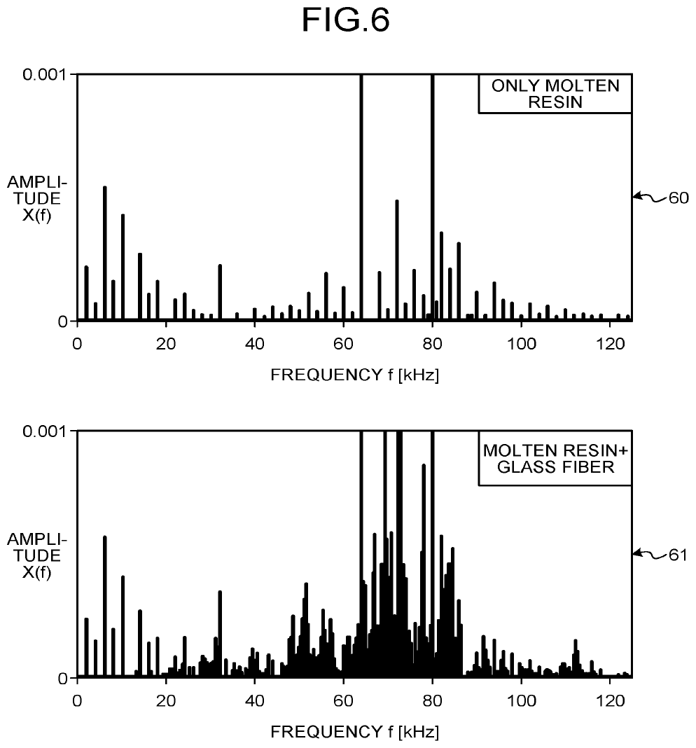

FIG. 6 is a diagram illustrating an example of a result of frequency analysis of AE waves acquired by an AE wave analysis device. A graph 60 illustrated in FIG. 6 illustrates an example of a frequency distribution of an amplitude X (f) of the AE output M(t) acquired by the AE sensor 20 when the resin raw material that has been melted and reached the steady state is conveyed by the twin-screw extrusion molding machine 30. The horizontal axis of the graph 60 represents a frequency f. The vertical axis of the graph 60 represents the amplitude of the component of the frequency f obtained by performing discrete Fourier transform on the AE output M(t). Note that the discrete Fourier transform was performed using an FFT algorithm. Furthermore, the AE output M(t) is sampled at a sampling frequency of 250 kHz.

A graph 61 illustrates an example of a frequency distribution of the amplitude X (f) of the AE output M(t) acquired when a certain amount of glass fiber is temporarily supplied to the resin raw material that has been melted and reached the steady state and these materials are conveyed by the twin-screw extrusion molding machine 30. The AE output M(t) was sampled at a sampling frequency of 250 kHz as in the graph 60.

The graph 60 shows peaks at several frequencies, which are intrinsic frequency components that occur when the twin-screw extrusion molding machine 30 is in operation. These frequency components are generated by, for example, motor vibration, valve opening and closing sound, inverter noise, and the like. It has been found that the AE wave W caused by the resin raw material is not generated when the twin-screw extrusion molding machine 30 conveys only the molten resin raw material.

On the other hand, when the breakage of the glass fiber occurs inside the twin-screw extrusion molding machine 30, it has been found by comparing the graph 60 with the graph 61 that the AE output M(t) with a large amplitude is generated particularly in the frequency band of 60 kHz to 80 KHz.

Next, the inventors applied a bandpass filter of 60 kHz to 80 kHz to the amplitude X (f) illustrated in FIG. 6 in order to visualize how the breakage of the glass fiber proceeds with time. Next, a power spectrum from 60 kHz to 80 kHz was calculated. The integrated value S(t) of the calculated power spectrum over 0.2 seconds was then calculated, and its temporal change was observed.

Note that the power spectrum P(f) of a signal with the frequency f is calculated by equation (1).

P(f)=|X(f)|²=(X(f)*X(f))/n² (1)

In the equation, X (f) is the amplitude described above, and n is the number of data points.

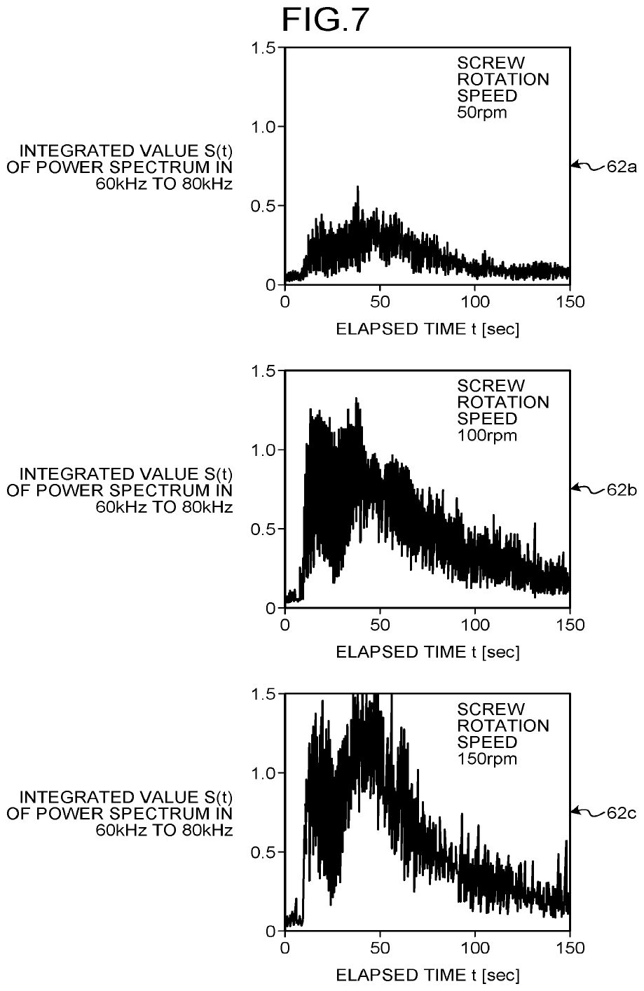

FIG. 7 is a diagram illustrating an example of a temporal change in an integrated value of a power spectrum of AE waves acquired by the AE wave analysis device in a range of 60 kHz to 80 KHz.

Graphs 62a, 62b, and 62c illustrated in FIG. 7 illustrate a temporal change in the integrated value of the power spectrum of the AE output M(t) acquired by the AE wave analysis device 10 in the range of 60 kHz to 80 kHz in a case where the screw 44 is rotated at different rotation speeds. The graph 62a illustrates the integrated value S (t) in a case where the screw rotation speed is 50 rpm. The graph 62b illustrates the integrated value S(t) in a case where the screw rotation speed is 100 rpm. The graph 62c illustrates the integrated value S(t) in a case where the screw rotation speed is 150 rpm.

As can be seen from the graphs 62a, 62b, and 62c, in any of the graphs, the integrated value S(t) monotonically increases with time, and then monotonically decreases. That is, it has been found that the breakage of the glass fiber occurs at a high frequency immediately after the glass fiber is fed. In addition, it has been found that since the length of the glass fiber decreases with time, the frequency of occurrence of breakage decreases, the state where the size (length) of the glass fiber does not change with time is reached, that is, the kneading state of the raw material reaches the steady state.

Furthermore, it has been found that the integrated value S(t), that is, the amplitude of the 60 to 80 KHz components of the AE waves W increases as the rotation speed of the screw 44 increases. It is considered that this is because the frequency of breakage of the glass fiber increases as the rotation speed of the screw 44 increases.

From these results, the inventors have considered that when the integrated value S(t) monotonically decreases and the change thereof becomes gentle, it can be determined that the broken state of the glass fiber reaches the steady state.

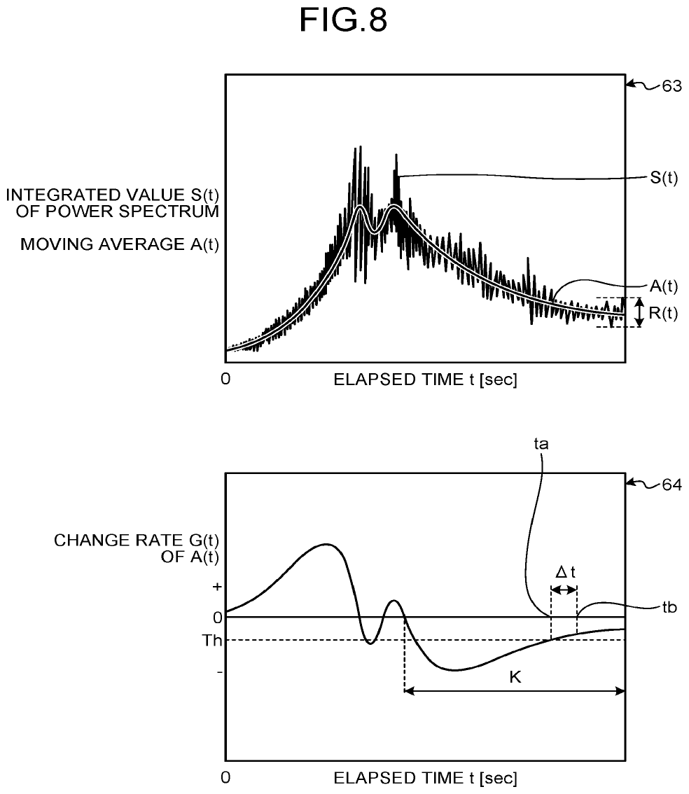

FIG. 8 is a diagram for explaining a method of determining whether the broken state of glass fiber has reached the steady state on the basis of the waveform of the AE wave acquired by the AE wave analysis device.

Since the waveform of the integrated value S(t) varies largely, the AE wave analysis device 10 first calculates a moving average A(t) of the integrated value S (t) to smooth the waveform. The moving average is a type of low-pass filter, and is used in analyzing a global trend of a waveform by smoothing a given waveform. The time interval for calculating the moving average may be freely set, but if the time interval is too short, a noise component remains, and if the time interval is too long, the waveform is too blunt. Therefore, it is desirable to perform an evaluation experiment and set an appropriate time interval. For example, the moving average A(t) is obtained from the integrated value S(t) illustrated in a graph 63 of FIG. 8.

Next, the AE wave analysis device 10 analyzes the temporal change of the moving average A(t). Specifically, as illustrated in a graph 64 of FIG. 8, the moving average A(t) is time-differentiated to calculate a change rate G(t) of the moving average A(t). That is, the change rate G(t) is calculated by equation (2).

G(t)=dA(t)/dt (2)

From the results of the evaluation experiments described above, it has been found that the moving average A(t) monotonically decreases and becomes gentle when the glass fiber is broken and reaches the steady state, and thus the AE wave analysis device 10 first searches for a section in which the moving average A(t) monotonically decreases. The section in which the moving average A(t) monotonically decreases is specified, for example, by searching for a place where a section satisfying G(t)≤0 is continuous over a predetermined time Δt. In the case of the graph 64, a section K is specified as the section in which the moving average A(t) monotonically decreases.

Next, the AE wave analysis device 10 searches for a time t when all the absolute values of the change rate G(t) are equal to or less than a threshold Th over the predetermined time Δt in the section K in which the moving average A(t) monotonically decreases. In the case of the graph 64, a time ta is found. That is, the absolute values of the change rate G(t) are all equal to or less than the threshold Th from the time ta to a time tb after the predetermined time Δt. The AE wave analysis device 10 determines that at the time ta, the breakage of the glass fiber has reached the steady state, that is, the molding of the product is ready to be started using the twin-screw extrusion molding machine 30.

On the other hand, in a case where the conditions described above are not satisfied, the AE wave analysis device 10 determines that the breakage of the glass fiber has not reached the steady state, that is, the operation of the twin-screw extrusion molding machine 30 needs to be continued.

### [Functional Configuration of Kneading State Detection Device]

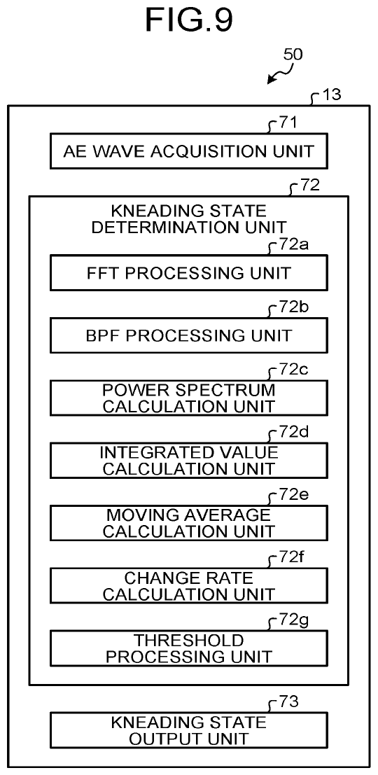

Next, the functional configuration of the kneading state detection device 50 according to the embodiment will be described with reference to FIG. 9. FIG. 9 is a functional block diagram illustrating an example of a functional configuration of the kneading state detection device for the twin-screw extrusion molding machine according to the embodiment. The control unit 13 of the kneading state detection device 50 develops the control program P1 in the RAM 13c and operates the control program P1, thereby implementing an AE wave acquisition unit 71, a kneading state determination unit 72, and a kneading state output unit 73 illustrated in FIG. 9 as functional units.

The AE wave acquisition unit 71 acquires the output of the AE sensor 20 installed on the housing 32 of the twin-screw extrusion molding machine 30 when the twin-screw extrusion molding machine 30 that kneads raw materials or kneads the raw material and a reinforcing material for improving the strength of the raw material is in operation. More specifically, the AE wave acquisition unit 71 includes an amplifier and amplifies the detection signal D detected by the AE sensor 20, and converts the effective value of the detection signal D as an analog signal into the AE output M(t) as a digital signal by the A/D converter 17. Note that the AE wave acquisition unit 71 is an example of an acquisition unit in the present disclosure.

The kneading state determination unit 72 determines the kneading state of the resin raw material and the glass fiber on the basis of the comparison between the change in the intensity of the AE output M(t) of the AE sensor 20 acquired by the AE wave acquisition unit 71 over a predetermined time and a threshold. Note that the kneading state determination unit 72 is an example of a determination unit in the present disclosure. The kneading state determination unit 72 further includes an FFT processing unit 72a, a BPF processing unit 72b, a power spectrum calculation unit 72c, an integrated value calculation unit 72d, a moving average calculation unit 72e, a change rate calculation unit 72f, and a threshold processing unit 72g.

The FFT processing unit 72a performs FFT on the AE output M (t).

The BPF processing unit 72b applies a bandpass filter (BPF) in a predetermined frequency range to the result of the FFT. Note that the predetermined frequency range is, for example, 60 kHz to 80 KHz.

The power spectrum calculation unit 72c calculates the power spectrum P (f) in the predetermined frequency range calculated by the BPF processing unit 72b.

The integrated value calculation unit 72d calculates the integrated value S(t) for a predetermined time for the power spectrum P (f) in the predetermined frequency range. The predetermined time is, for example, 0.2 seconds.

The moving average calculation unit 72e calculates the moving average A(t) of the integrated value S(t).

The change rate calculation unit 72f calculates the change rate G(t) of the moving average A(t).

The threshold processing unit 72g searches for the time t when all the absolute values of the change rate G(t) of the moving average A(t) are equal to or less than the threshold Th over the predetermined time Δt. The threshold processing unit 72g then determines that the kneading state of the raw material has reached the steady state at the time t.

The threshold processing unit 72g may determine that the kneading state of the raw material has reached the steady state in a case where the amplitude R(t) (see FIG. 8) of the integrated value S(t) falls between a first threshold and a second threshold larger than the first threshold over the predetermined time Δt, without using the moving average A(t). The first threshold and the second threshold are appropriately set according to the conditions for kneading raw materials.

The kneading state output unit 73 outputs a determination result related to the kneading state of the raw material determined by the kneading state determination unit 72. Note that the determination result is displayed on the display device 18. Note that the output method of the kneading state output unit 73 is not limited thereto. An indicator (not illustrated in FIG. 5) may be turned on or blink to make notification that the broken state of the glass fiber has reached the steady state, or a sound or a voice may be output from a speaker or a buzzer (not illustrated in FIG. 5) to make notification that the broken state of the glass fiber has reached the steady state.

### [Flow of Process Performed by Kneading State Detection Device]

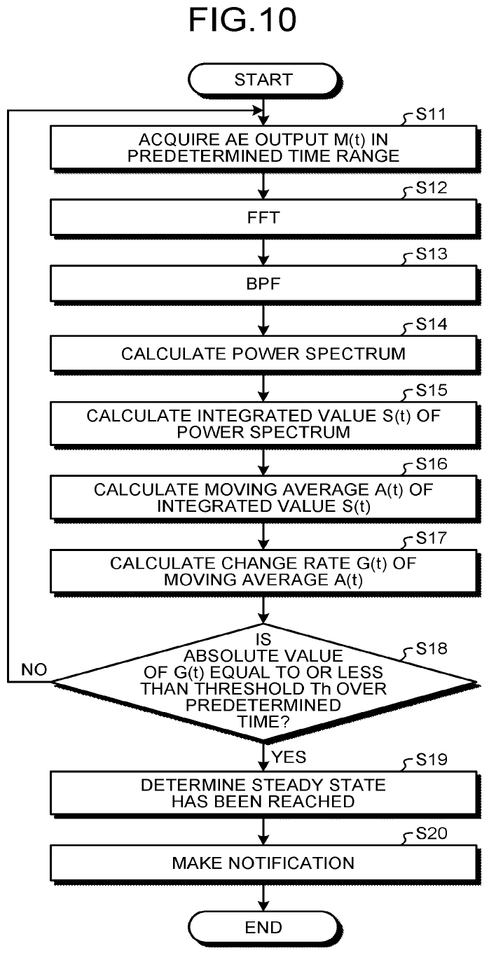

Next, a flow of a process performed by the kneading state detection device 50 according to the embodiment will be described with reference to FIG. 10. FIG. 10 is a flowchart illustrating an example of a flow of a process performed by the kneading state detection device.

The AE wave acquisition unit 71 acquires the AE output M(t) in a predetermined time range (step S11). Note that the predetermined time is a time range in which the number of data necessary for performing FFT in step S12 can be acquired.

The FFT processing unit 72a performs FFT on the AE output M(t) (step S12).

The BPF processing unit 72b applies a bandpass filter that cuts the outputs outside the predetermined frequency range to the result of the FFT (step S13). In the present embodiment, the predetermined frequency range is 60 kHz to 80 KHz.

The power spectrum calculation unit 72c calculates a power spectrum for the result of application of the band pass filter (step S14).

Next, the integrated value calculation unit 72d calculates the integrated value S(t) of the power spectrum (step S15).

The moving average calculation unit 72e calculates the moving average A(t) of the integrated value S(t) (step S16).

The change rate calculation unit 72f calculates the change rate G(t) of the moving average A(t) (step S17).

The threshold processing unit 72g determines whether the absolute value of the change rate G(t) of the moving average A(t) is equal to or less than the threshold Th over the predetermined time Δt (step S18). When it is determined that the condition is satisfied (step S18: Yes), the process proceeds to step S19. On the other hand, when it is not determined that the condition is satisfied (step S18: No), the process returns to step S11.

When it is determined in step S18 that the absolute value of the change rate G(t) of the moving average A(t) is equal to or less than the threshold Th over the predetermined time Δt, the threshold processing unit 72g determines that the kneading state of the raw material has reached the steady state (step S19).

The kneading state output unit 73 make notification to indicate, on the display device 18, the kneading state of the raw material has reached the steady state (step S20). Thereafter, the kneading state detection device 50 ends the process of FIG. 10.

Note that, when it is not determined in step S18 that the absolute value of the change rate G(t) of the moving average A(t) is equal to or less than the threshold Th for the predetermined time Δt, the kneading state output unit 73 may make notification to indicate, on the display device 18, that the kneading state of the raw material has not reached the steady state.

In addition, the threshold processing unit 72g may determine in step S18 that the kneading state of the raw material has reached the steady state in a case where the change rate G(t) of the moving average A(t) is a negative value over the predetermined time Δt, that is, the change rate G (t) monotonically decreases and the absolute value of the change rate G (t) is equal to or less than the threshold Th over the predetermined time Δt.

As described above, the kneading state detection device 50 according to the first embodiment includes the AE wave acquisition unit 71 (acquisition unit) that acquires the AE output M(t) of the AE sensor 20 installed on the housing 32 of the twin-screw extrusion molding machine 30 when the twin-screw extrusion molding machine 30 that kneads raw materials or kneads the raw material and an additive is in operation, and the kneading state determination unit 72 (determination unit) that determines the kneading state of the raw materials or the raw material and the additive on the basis of the comparison between the change in the intensity of the AE output M(t) of the AE sensor 20 acquired by the AE wave acquisition unit 71 over a predetermined time and the threshold Th. Therefore, at each element point inside the twin-screw extrusion molding machine 30, it is possible to reliably detect in real time whether there is no temporal change in the breaking amount of the glass fiber or the kneading condition of the resin raw material and the glass fiber, that is, whether the kneading state of raw materials is stabilized. In addition, even in an area that cannot be determined by a pressure sensor, a temperature sensor, a torque sensor, or the like, the kneading state of the raw materials can be determined. Moreover, since the kneading state of the raw materials can be determined in real time, the waste of the raw materials can be reduced.

The kneading state detection device 50 according to the first embodiment also includes the integrated value calculation unit 72d that calculates the integrated value S (t) of the power spectrum of the AE output M(t) from the AE sensor 20 in a predetermined frequency region, and the moving average calculation unit 72e that calculates the moving average A(t) of the temporal change of the integrated value S(t). The kneading state determination unit 72 (determination unit) determines that the kneading state of the raw materials or the raw material and the additive is stabilized in a case where the absolute value of the change rate G(t) of the moving average A(t) is equal to or less than the predetermined threshold Th over the predetermined time Δt. Therefore, the kneading state of the raw materials can be reliably detected in real time.

Furthermore, in the kneading state detection device 50 according to the first embodiment, the kneading state determination unit 72 (determination unit) determines that the kneading state of the raw materials is stabilized in a case where the moving average A(t) of the temporal change of the integrated value S (t) monotonically decreases with time and the absolute value of the change rate G(t) of the moving average A(t) is equal to or less than the predetermined threshold Th over the predetermined time Δt. Therefore, the kneading state of the raw materials can be reliably determined in real time.

Moreover, in the kneading state detection device 50 according to the first embodiment, the kneading state determination unit 72 (determination unit) may determine that the kneading state of the raw materials is stabilized in a case where the temporal change of the integrated value S(t) falls between a first threshold and a second threshold larger than the first threshold over the predetermined time Δt. Therefore, the kneading state of the raw materials can be reliably determined in real time.

Furthermore, in the kneading state detection device 50 according to the first embodiment, the AE sensor 20 is installed downstream of the feeding port of the resin raw material and the glass fiber in the twin-screw extrusion molding machine 30. Therefore, it is possible to reliably determine whether the kneading state of the raw materials is stabilized. In addition, since the AE sensor 20 is attached in the vicinity of the kneading position, the response speed is high, and the kneading state of the raw materials can be determined in real time.

Furthermore, in the kneading state detection device 50 according to the first embodiment, the kneading state determination unit 72 (determination unit) determines that the state where the size of the glass fiber does not change with time is reached when the glass fiber (reinforcing material) is fed into the molten resin raw material conveyed in the twin-screw extrusion molding machine 30. Therefore, at each element point inside the twin-screw extrusion molding machine 30, it is possible to reliably detect whether there is no temporal change in the breaking amount of the glass fiber, that is, whether the breaking (kneading) state of the glass fiber is stabilized.

In the kneading state detection device 50 according to the first embodiment, the reinforcing material is glass fiber. Therefore, a molded article with improved strength can be reliably produced.

### Modification of First Embodiment

In the embodiment described above, an example has been described in which, when glass fiber is fed into molten resin pellets, the kneading state detection device 50 determines whether the glass fiber is broken and reaches the steady state. The kneading state detection device 50 further observes the AE wave W and performs signal processing similar to that described above, thereby determining whether the unmelted resin pellets fed into the twin-screw extrusion molding machine 30 are crushed and melted to reach the steady state.

Furthermore, it is also possible to determine whether, in a state where the unmelted resin pellets and the glass fiber are mixed, the resin pellets are crushed and melted, and the glass fiber has reached the steady state where the size of the glass fiber does not change with time.

As described above, in the kneading state detection device 50 according to a modification of the first embodiment, the kneading state determination unit 72 (determination unit) determines that, when the unmelted resin pellets and the glass fiber (reinforcing material) are fed into the twin-screw extrusion molding machine 30, the state where the resin pellets are crushed and melted, and the size of the glass fiber does not change with time is reached. Therefore, it is possible to reliably and easily determine the kneading state of the resin raw material and the reinforcing material.

### Second Embodiment

When the twin-screw extrusion molding machine 30 is operated to knead raw materials, the raw materials are continuously fed for a long time. During the operation of the twin-screw extrusion molding machine 30, the operating conditions may be changed in the middle of the operation. The operating conditions include, for example, a change in the rotation speed of the screw 44, a change in the flow rate of a resin raw material or glass fiber to be fed, and the like. The kneading state detection device 50 can determine whether the kneading state of the raw materials is stabilized in real time even in such a continuous operation scene. Note that, in the case of the continuous operation, since new raw materials and an additive are constantly fed, unlike the first embodiment, AE waveforms due to the breakage of the raw materials are constantly output. In a state where the inside of the twin-screw extrusion molding machine 30 is filled with the fed raw materials, the temporal change of the AE waveforms to be output is reduced. This state is a steady state in the continuous operation. The kneading state detection device 50 can also determine that it has reached such a steady state in the continuous operation.

### First Operation Example of Second Embodiment

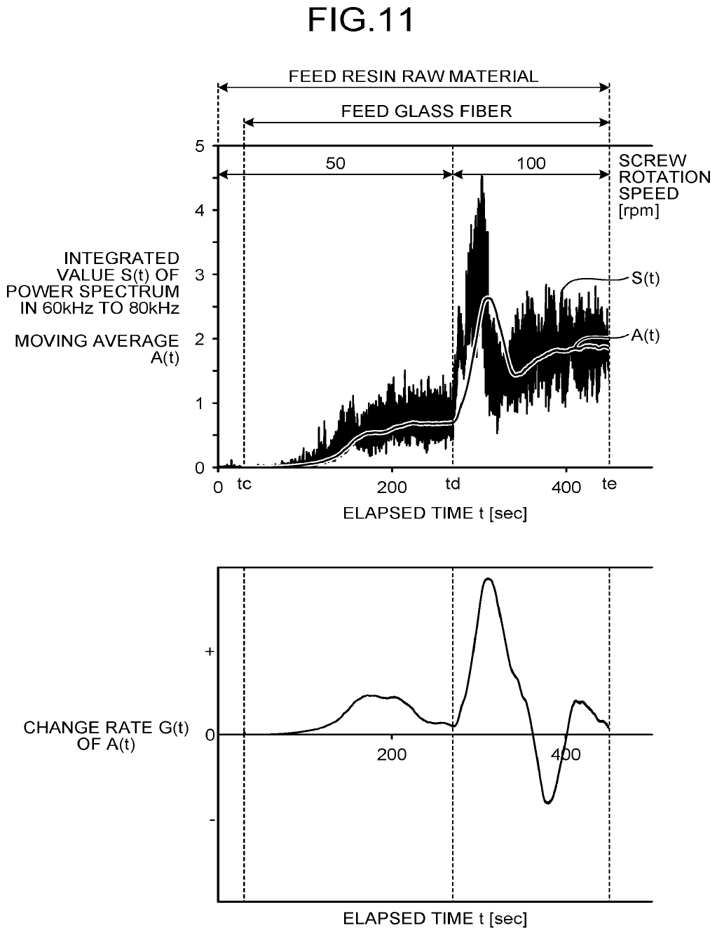

FIG. 11 is a diagram illustrating an example of a temporal change in the integrated value of a power spectrum when the rotation speed of a screw is changed in a state where the resin raw material and the glass fiber are sufficiently kneaded by continuously operating the twin-screw extrusion molding machine.

In FIG. 11, the screw 44 rotates at 50 rpm from a time 0 to a time td. Then, at the time td when the kneading state reaches the steady state, the rotation speed of the screw 44 is increased to 100 rpm, and the screw 44 rotates at 100 rpm from the time td to a time te. The resin raw material is continuously fed into the supply port 36a (see FIG. 3) from the time 0, and the glass fiber is continuously fed into the side feeder 37 (see FIG. 3) from a time tc. The flow rate of the resin raw material is 5 kg/h, and the flow rate of the glass fiber is 0.5 kg/h.

In a case where the absolute value of the change rate G(t) of the moving average A(t) of the integrated value S (t) is equal to or less than the predetermined threshold Th over the predetermined time Δt, the kneading state determination unit 72 of the kneading state detection device 50 determines that the kneading state of the raw materials is stabilized (has reached the steady state). It is difficult to understand in the graph illustrating the change rate G(t) in FIG. 11 because the time axis compression rate is high, but the inventors have checked that the temporal change of the change rate G(t) is equal to or less than a predetermined threshold over a predetermined time in the latter half of the section under the same operating conditions.

Therefore, even in a case where the operating conditions are changed during the continuous operation, the determination method (see FIG. 10) described in the first embodiment can be applied as it is in the section under the same operating conditions.

### Second Operation Example of Second Embodiment

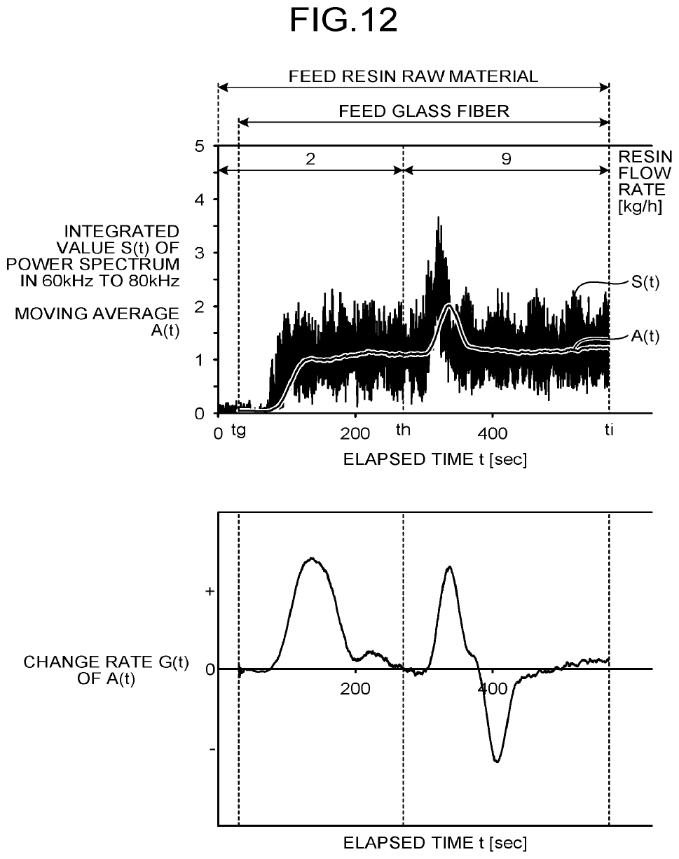

FIG. 12 is a diagram illustrating an example of the temporal change in the integrated value of the power spectrum when the rotation speed of the screw is changed in a state where the resin raw material and the glass fiber are sufficiently kneaded by continuously operating the twin-screw extrusion molding machine.

In FIG. 12, the resin raw material is continuously fed at a flow rate of 2 kg/h from the time 0 to a time th. At the time th when the kneading state reaches the steady state, the flow rate of the resin raw material is increased, and the resin raw material is continuously fed at a flow rate of 9 kg/h from the time th to a time ti. The glass fiber is continuously fed at a flow rate of 0.5 kg/h from a time tg. Note that the rotation speed (100 rpm) of the screw 44 is constant.

In a case where the absolute value of the change rate G(t) of the moving average A(t) of the integrated value S (t) is equal to or less than the predetermined threshold Th over the predetermined time Δt, the kneading state determination unit 72 of the kneading state detection device 50a determines that the kneading state of the raw materials is stabilized (has reached the steady state). It is difficult to understand in the graph illustrating the change rate G(t) in FIG. 12 because the time axis compression rate is high, but the inventors have checked that the temporal change of the change rate G(t) is equal to or less than a predetermined threshold over a predetermined time in the latter half of the section under the same operating conditions.

Therefore, even in a case where the operating conditions are changed during the continuous operation, the determination method (see FIG. 10) described in the first embodiment can be applied as it is in the section under the same operating conditions.

### Third Operation Example of Second Embodiment

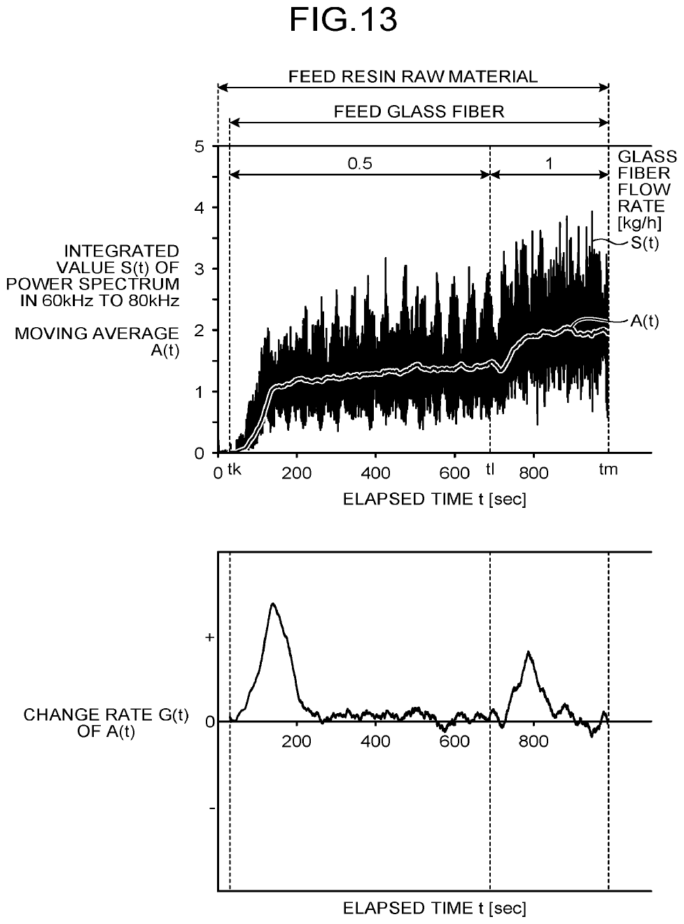

FIG. 13 is a diagram illustrating an example of the temporal change in the integrated value of the power spectrum when the feeding flow rate of the glass fiber is changed in a state where the resin raw material and the glass fiber are sufficiently kneaded by continuously operating the twin-screw extrusion molding machine.

In FIG. 13, the glass fiber is continuously fed at a flow rate of 0.5 kg/h from a time tk to a time tl. At the time tl when the kneading state reaches the steady state, the flow rate of the glass fiber is increased, and the glass fiber is continuously fed at a flow rate of 1 kg/h from the time tl to a time tm. The resin raw material is continuously fed at a flow rate of 5 kg/h from the time 0. Note that the rotation speed (100 rpm) of the screw 44 is constant.

In a case where the absolute value of the change rate G(t) of the moving average A(t) of the integrated value S(t) is equal to or less than the predetermined threshold Th over the predetermined time Δt, the kneading state determination unit 72 of the kneading state detection device 50a determines that the kneading state of the raw materials is stabilized (has reached the steady state). It is difficult to understand in the graph illustrating the change rate G(t) in FIG. 13 because the time axis compression rate is high, but the inventors have checked that the temporal change of the change rate G(t) is equal to or less than a predetermined threshold over a predetermined time in the latter half of the section under the same operating conditions.

Therefore, even in a case where the operating conditions are changed during the continuous operation, the determination method (see FIG. 10) described in the first embodiment can be applied as it is in the section under the same operating conditions.

As described above, the kneading state detection device 50 according to the second embodiment includes the integrated value calculation unit 72d that calculates the integrated value S(t) of the power spectrum of the AE output M(t) from the AE sensor 20 in a predetermined frequency region, and the moving average calculation unit 72e that calculates the moving average A(t) of the integrated value S(t). In a state where the raw materials are continuously supplied, the kneading state determination unit 72 (determination unit) determines that, at each element point inside the twin-screw extrusion molding machine 30, the kneading state of the raw materials fed into the twin-screw extrusion molding machine 30 has no temporal change, that is, has reached the steady state in a case where the absolute value of the change rate G(t) of the moving average A(t) is equal to or less than the predetermined threshold Th over the predetermined time Δt. Therefore, even in a case where the twin-screw extrusion molding machine 30 is continuously operated and the raw materials are continuously supplied, the kneading state of the raw materials can be reliably determined.

Although the embodiments of the present invention have been described above, these embodiments are merely examples and are not intended to limit the scope of the invention. This novel embodiment can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

### EXPLANATIONS OF LETTERS OR NUMERALS

10 AE WAVE ANALYSIS DEVICE
20 AE SENSOR
30 TWIN-SCREW EXTRUSION MOLDING MACHINE (EXTRUSION MOLDING MACHINE)
32 HOUSING (BARREL)
36a, 36b SUPPLY PORT
42 OUTPUT SHAFT
44 SCREW
46 KNEADING DISK
50 KNEADING STATE DETECTION DEVICE
71 AE WAVE ACQUISITION UNIT (ACQUISITION UNIT)
72 KNEADING STATE DETERMINATION UNIT (DETERMINATION UNIT)
72a FFT PROCESSING UNIT
72b BPF PROCESSING UNIT
72c POWER SPECTRUM CALCULATION UNIT
72d INTEGRATED VALUE CALCULATION UNIT
72e MOVING AVERAGE CALCULATION UNIT
72f CHANGE RATE CALCULATION UNIT
72g THRESHOLD PROCESSING UNIT
73 KNEADING STATE OUTPUT UNIT
A(t) MOVING AVERAGE
f FREQUENCY
G(t) CHANGE RATE
K SECTION
M (t) AE OUTPUT
P (f) POWER SPECTRUM
Th THRESHOLD
W AE WAVE
X(f) AMPLITUDE
Δt PREDETERMINED TIME

1-12. (canceled)

13. A kneading state detection device for an extrusion molding machine, comprising:
an acquisition unit that, when an extrusion molding machine that kneads a raw material or kneads a raw material and an additive is in operation, acquires an output of an AE sensor installed on a housing of the extrusion molding machine;
an integrated value calculation unit that calculates an integrated value of a power spectrum of an output of the AE sensor in a predetermined frequency region;
a moving average calculation unit that calculates a moving average of a temporal change of the integrated value; and
a determination unit that determines a kneading state of the raw material or the raw material and the additive is stabilized in a case where an absolute value of a change rate of the moving average is equal to or less than a predetermined threshold over a predetermined time.

14. The kneading state detection device for the extrusion molding machine according to claim 13, wherein the determination unit determines that the kneading state is stabilized in a case where the moving average monotonically decreases with time and an absolute value of a change rate of the moving average is equal to or less than a predetermined threshold over a predetermined time.

15. The kneading state detection device for the extrusion molding machine according to claim 14, wherein the determination unit determines that the kneading state is stabilized in a case where the temporal change of the integrated value falls between a first threshold and a second threshold larger than the first threshold over a predetermined time.

16. The kneading state detection device for the extrusion molding machine according to claim 13, wherein the AE sensor is installed downstream of a feeding port of the raw material or a feeding port of the raw material and the additive in the extrusion molding machine.

17. The kneading state detection device for the extrusion molding machine according to claim 13, wherein the determination unit determines that, when an additive is fed into a molten resin raw material conveyed in the extrusion molding machine, a state where a size of the additive does not change with time is reached.

18. The kneading state detection device for the extrusion molding machine according to claim 13, wherein the determination unit determines that, when a resin raw material which is unmelted, and an additive are fed into the extrusion molding machine, a state where the resin raw material is crushed and melted, and a size of the additive does not change with time is reached.

19. The kneading state detection device for the extrusion molding machine according to claim 13, wherein the additive comprises a glass fiber.

20. A kneading state detection method for an extrusion molding machine, comprising:
when the extrusion molding machine that kneads a raw material or kneads a raw material and an additive is in operation, acquiring an output of an AE sensor installed on a housing of the extrusion molding machine, and calculating an integrated value of a power spectrum of the acquired output of the AE sensor in a predetermined frequency region;
calculating a moving average of a temporal change of the integrated value; and
determining that a kneading state of the raw material or the raw material and the additive is stabilized in a case where an absolute value of a change rate of the moving average is equal to or less than a predetermined threshold over a predetermined time.

21. The kneading state detection method for the extrusion molding machine according to claim 20, comprising:
determining that the kneading state is stabilized in a case where the moving average monotonically decreases with time and an absolute value of a change rate of the moving average is equal to or less than a predetermined threshold over a predetermined time.

22. The kneading state detection method for the extrusion molding machine according to claim 20, comprising:
determining that the kneading state is stabilized in a case where the temporal change of the integrated value falls between a first threshold and a second threshold larger than the first threshold over a predetermined time.
